(19) United States
(12) Patent Application Publication
(10) Pub. No.: US 2026/0227776 A1
(43) Pub. Date: Aug. 6, 2026

(54) Heat Exchanger Maintenance Planning Using Predictive Analytics

(71) Applicant: Chevron U.S.A. Inc., San Ramon, CA (US)

(72) Inventors: Albert C. van Roodselaar, Houston, TX (US); Justin Thomas Monroe, Houston, TX (US); Luc Johan Christiaan Huyse, Katy, TX (US)

(21) Appl. No.: 19/155,117

(22) PCT Filed: Feb. 1, 2024
(86) PCT No.: PCT/US2024/013941

§ 371 Date: Aug. 8, 2025

Related U.S. Application Data
(60) Provisional application No. 63/484,032, filed on Feb. 9, 2023.

(51) Int. Cl. G05B 23/02; F28F 27/00

(52) U.S. Cl. CPC G05B 23/0283; F28F 27/00; F28F 2200/00

(57) ABSTRACT

A computing system, method, and computer-readable medium includes a fouling analytics tool and a maintenance analytics tool for managing heat exchanger maintenance. The fouling analytics tool calculates a fouling rate for the heat exchanger using operation data and calculates an exceed time for when the process threshold is exceeded based upon the fouling rate. A total fouling inefficiency rate for the heat exchanger is based on the fouling rate, a heat exchanger energy efficiency rate, and a heat exchanger lost production rate. An optimal time for performing fouling maintenance on the heat exchanger is determined based upon the total fouling inefficiency rate for the heat exchanger and a cost associated with performing the maintenance. The maintenance analytics tool can further evaluate abnormal operation data and integrity data for the heat exchanger so that maintenance decisions can be based on one or both of fouling and degradation analysis.

### RELATED APPLICATIONS

The present application is a national phase application of and claims the benefit of PCT Patent Application No. PCT/US2024/013941 filed Feb. 1, 2024, which claims priority to U.S. Provisional Patent Application No. 63/484,032 filed Feb. 9, 2023. The entire content of the foregoing applications is incorporated herein by reference.

### TECHNICAL FIELD

Embodiments of the technology relate generally to applying predictive analytics to planning maintenance for heat exchanger equipment.

### BACKGROUND

Heat exchangers can be used throughout the upstream, midstream, and downstream refining and processing of hydrocarbons. A large energy company can have hundreds or thousands of heat exchangers operating in various processes and locations. Additionally, heat exchangers can be large and complex pieces of equipment often comprising more than 100 heat exchanger tubes that provide the heat transfer capabilities of the heat exchanger. Accordingly, managing the operation and maintenance of the numerous heat exchangers can be a substantial undertaking for energy companies.

Managing the operation and maintenance of heat exchangers typically includes considering fouling rates and degradation. The fouling rate is the rate at which deposits accumulate on the heat exchanger's surfaces due to its operation. The fouling rate is important because the accumulation of deposits on the heat exchanger's surfaces impairs the efficiency of the heat exchanger. Degradation refers to the components of the heat exchanger degrading over time due to corrosion and erosion caused by the operation of the heat exchanger.

Maintenance of a heat exchanger involves shutting down the heat exchanger and the associated equipment in order to clean the accumulated fouling deposits from the surface of the heat exchanger, replacing components that have degraded, or replacing the entire heat exchanger when necessary. Existing approaches to managing heat exchangers rely upon conservative estimates to determine when maintenance or replacement of a heat exchanger should occur. However, these approaches are limited in that they do not support robust analysis of a variety of operation and efficiency data associated with a heat exchanger. Existing approaches also fail to use robust data analysis to predict future operating conditions and the need for future maintenance on heat exchangers. Due to the lack of robust approaches to analyzing the state of heat exchangers, maintenance of heat exchangers often relies upon overly conservative maintenance schedules resulting in unnecessary downtime of the heat exchangers and related equipment. When the unnecessary downtime is multiplied across hundreds or thousands of heat exchangers in an energy company's operations, substantial inefficiencies result. In addition to the costs associated with lost operating time of the heat exchangers, given the many components and the complexity of the heat exchangers, performing a single maintenance operation on a single heat exchanger typically costs approximately $50,000. Given the foregoing challenges associated with operating and maintaining heat exchangers, improved approaches to managing and planning maintenance for heat exchangers would be beneficial.

### SUMMARY

The present disclosure is directed to managing the maintenance of heat exchangers. In one example embodiment, the present disclosure is directed to a computing system comprising a processor, a memory, and a storage device comprising a fouling analytics tool. The fouling analytics tool can comprise computer-executable instructions that: (i) receive operation data for a heat exchanger; (ii) receive a process threshold for the heat exchanger; (iii) calculate a fouling rate for the heat exchanger based upon the operation data; (iv) calculate an exceed time that occurs when the process threshold is exceeded based upon the fouling rate; (v) calculate a total fouling inefficiency rate for the heat exchanger based on the fouling rate, an energy efficiency rate for heat exchanger, and a lost production rate for the heat exchanger; (vi) calculate an optimal time for performing fouling maintenance on the heat exchanger based upon the total fouling inefficiency rate for the heat exchanger and a cost associated with performing the maintenance; and (vii) provide a recommended maintenance plan based upon the optimal time for performing fouling maintenance on the heat exchanger.

The foregoing system can include one or more of the following additional features. The storage device can further comprise a maintenance analytics tool that comprises computer-executable instructions that: (i) receive integrity data for the heat exchanger; (ii) receive abnormal operation data for the heat exchanger; (iii) calculate a degradation rate for the heat exchanger based upon the integrity data and the abnormal operation data; and (iv) calculate an optimal time for performing maintenance on the heat exchanger based upon the degradation rate and the total fouling inefficiency rate. In the foregoing system, the operation data for heat exchanger can comprise resistance factor data and temperature data. In the foregoing system, the process threshold for the heat exchanger can be one of a temperature threshold, a fuel usage threshold, and a production threshold. In the foregoing system, calculating the energy efficiency rate can be based upon the fouling rate, the exceed time, a fuel cost, and an emissions rate. In the foregoing system, the maintenance analytics tool can further comprise computer-executable instructions that: (i) receive integrity data for at least a second heat exchanger; (ii) receive abnormal operation data for at least the second heat exchanger; and (iii) use the integrity data and the abnormal operation data for at least the second heat exchanger when calculating the degradation rate for the heat exchanger. In the foregoing system, the fouling analytics tool can further comprise computer-executable instructions that: (i) calculate an optimal time for performing fouling maintenance on a second heat exchanger, wherein the heat exchanger and the second heat exchanger comprise a heat exchanger bank; and (ii) calculate an optimal time for performing fouling maintenance on the heat exchanger bank by averaging the optimal time for the heat exchanger and the optimal time for the second heat exchanger.

In another example embodiment, the present disclosure is directed to a method for managing maintenance of a heat exchanger. The method can comprise: (i) receiving operation data for the heat exchanger; (ii) receiving a process threshold for the heat exchanger; (iii) calculating, by a fouling analytics tool, a fouling rate for the heat exchanger based upon the operation data; (iv) calculating, by the fouling analytics tool, an exceed time that occurs when the process threshold is exceeded based upon the fouling rate; (v) calculating, by the fouling analytics tool, a total fouling inefficiency rate for the heat exchanger based on the fouling rate, an energy efficiency rate for heat exchanger, and a lost production rate for the heat exchanger; (vi) calculating, by the fouling analytics tool, an optimal time for performing fouling maintenance on the heat exchanger based upon the total fouling inefficiency rate for the heat exchanger and a cost associated with performing the maintenance; and (vii) providing, by the fouling analytics tool, a recommended maintenance plan based upon the optimal time for performing fouling maintenance on the heat exchanger.

The foregoing method can include one or more of the following additional features. The foregoing method can include: (i) receiving, by a maintenance analytics tool, integrity data for the heat exchanger; (ii) receiving, by the maintenance analytics tool, abnormal operation data for the heat exchanger; (iii) calculating, by the maintenance analytics tool, a degradation rate for the heat exchanger based upon the integrity data and the abnormal operation data; and (iv) calculating, by the maintenance analytics tool, an optimal time for performing maintenance on the heat exchanger based upon the degradation rate and the total fouling inefficiency rate. In the foregoing method, the operation data for the heat exchanger can comprise resistance factor data and temperature data. In the foregoing method, the process threshold for the heat exchanger can be one of a temperature threshold, a fuel usage threshold, and a production threshold. In the foregoing method, calculating the energy efficiency rate can be based upon the fouling rate, the exceed time, a fuel cost, and an emissions rate. The foregoing method can further comprise: (i) receiving, by the maintenance analytics tool, integrity data for at least a second heat exchanger; (ii) receiving, by the maintenance analytics tool, abnormal operation data for at least the second heat exchanger; and (iii) using the integrity data and the abnormal operation data for at least the second heat exchanger when calculating the degradation rate for the heat exchanger. The foregoing method can further comprise: (i) calculating, by the fouling analytics tool, an optimal time for performing fouling maintenance on a second heat exchanger, wherein the heat exchanger and the second heat exchanger comprise a heat exchanger bank; and (ii) calculating an optimal time for performing fouling maintenance on the heat exchanger bank by averaging the optimal time for the heat exchanger and the optimal time for the second heat exchanger.

In yet another example embodiment, the present disclosure is directed to a computer-readable medium comprising instructions that when executed by a processor perform a method comprising: (i) receiving operation data for the heat exchanger; (ii) receiving a process threshold for the heat exchanger; (iii) calculating, by a fouling analytics tool, a fouling rate for the heat exchanger based upon the operation data; (iv) calculating, by the fouling analytics tool, an exceed time that occurs when the process threshold is exceeded based upon the fouling rate; (v) calculating, by the fouling analytics tool, a total fouling inefficiency rate for the heat exchanger based on the fouling rate, an energy efficiency rate for heat exchanger, and a lost production rate for the heat exchanger; (vi) calculating, by the fouling analytics tool, an optimal time for performing fouling maintenance on the heat exchanger based upon the total fouling inefficiency rate for the heat exchanger and a cost associated with performing the maintenance; and (vii) providing, by the fouling analytics tool, a recommended maintenance plan based upon the optimal time for performing fouling maintenance on the heat exchanger.

The foregoing computer-readable medium can include one or more of the following additional features. The method of the foregoing computer-readable medium can include: (i) receiving, by a maintenance analytics tool, integrity data for the heat exchanger; (ii) receiving, by the maintenance analytics tool, abnormal operation data for the heat exchanger; (iii) calculating, by the maintenance analytics tool, a degradation rate for the heat exchanger based upon the integrity data and the abnormal operation data; and (iv) calculating, by the maintenance analytics tool, an optimal time for performing maintenance on the heat exchanger based upon the degradation rate and the total fouling inefficiency rate. The foregoing computer-readable medium can include wherein the operation data for the heat exchanger comprises resistance factor data and temperature data. The foregoing computer-readable medium can include wherein the process threshold for the heat exchanger is one of a temperature threshold, a fuel usage threshold, and a production threshold. The foregoing computer-readable medium can include wherein calculating the energy efficiency rate is based upon the fouling rate, the exceed time, a fuel cost, and an emissions rate. The method of the foregoing computer-readable medium can further include: (i) receiving, by the maintenance analytics tool, integrity data for at least a second heat exchanger; (ii) receiving, by the maintenance analytics tool, abnormal operation data for at least the second heat exchanger; and (iii) using the integrity data and the abnormal operation data for at least the second heat exchanger when calculating the degradation rate for the heat exchanger.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a system, method, and computer-readable media for managing the maintenance of heat exchangers. Therefore, the examples provided are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates an example architecture of a system for managing heat exchanger maintenance in accordance with an example embodiment of the disclosure.

FIG. 2 illustrates an example data structure for heat exchanger data in accordance with an example embodiment of the disclosure.

FIG. 3 is a flowchart illustrating an example method for determining a total fouling inefficiency rate over time for a heat exchanger in accordance with an example embodiment of the disclosure.

FIG. 4 is a flowchart illustrating an example method for calculating an optimal time for maintenance on a heat exchanger in accordance with an example embodiment of the disclosure.

FIG. 5 provides a plot of data associated with a heat exchanger in accordance with an example embodiment of the disclosure.

### DETAILED DESCRIPTION OF EXAMPLE EMBODIMENTS

The example embodiments discussed herein are directed to systems, methods, and computer-readable media for managing the maintenance of heat exchangers. While the example embodiments described herein involve heat exchangers, it should be understood that the embodiments also can be applied to other types of fluid carrying systems, including piping, pressure vessels, and valves. The example embodiments described herein use a maintenance analytics tool (“MAT”) and a fouling analytics tool (“FAT”) to evaluate a variety of data relating to the cleaning and replacement of heat exchangers and their components. The data analyzed by these tools can include heat exchanger operation data such as temperature, valve position, and resistance factor data; heat exchanger efficiency data such as production output, energy usage, and carbon emissions; and degradation data such as abnormal operating data and erosion/corrosion data.

By performing a robust analysis of these various categories of data, the tools described herein can provide more accurate predictions of the performance of the heat exchanger over time. These more accurate predictions allow for better decisions as to the optimal times for performing maintenance on a heat exchanger, thereby minimizing premature or unnecessary maintenance downtime. Considering the costs and downtime associated with performing maintenance on hundreds or thousands of heat exchangers, the techniques described herein allow for improved operation and maintenance of heat exchangers. As will be described further in the following examples, the systems, methods, and computer-readable media described herein improve upon existing approaches to managing the maintenance of heat exchangers. The improved approaches described herein can be embodied in a computer system, as a method executed by a computer system, and as a method embodied in a computer-readable medium.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

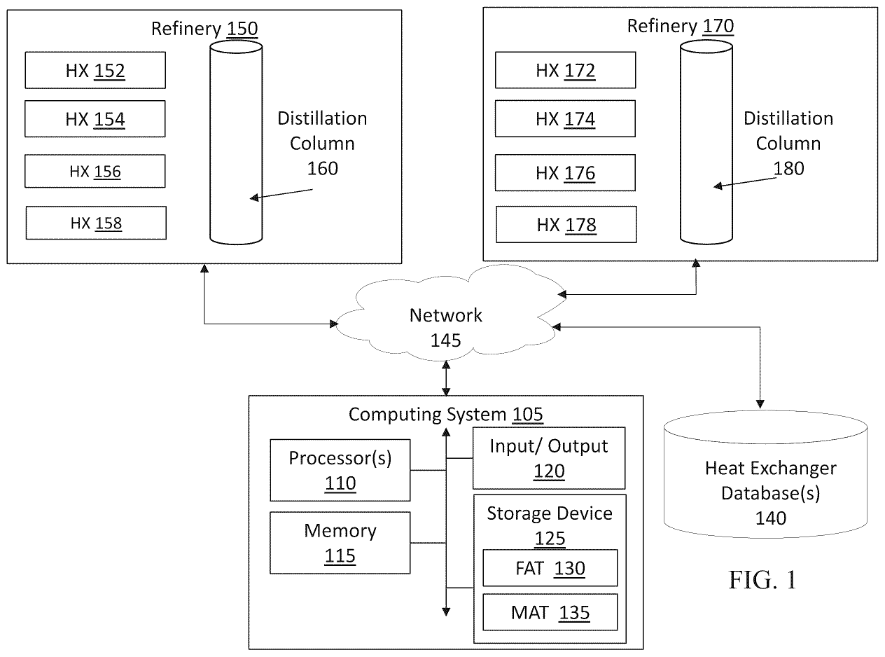

Referring now to FIG. 1, an example system for maintaining heat exchangers is illustrated. Heat exchangers can be found throughout various facilities and operations of an energy company, including both onshore and offshore facilities. For illustrative purposes, FIG. 1 provides two simplified hydrocarbon refineries with distillation columns and heat exchangers. It should be understood that the system and the refineries illustrated in FIG. 1 provide simplified representations and, in reality, refineries can include a substantial number of complex subsystems and components. As illustrated in FIG. 1, refinery 150 comprises a distillation column 160 and heat exchangers 152, 154, 156, and 158. Similarly, refinery 170 comprises distillation column 180 and heat exchangers 172, 174, 176, and 178. The heat exchangers illustrated in refineries 150 and 170 can operate in conjunction with the respective distillation columns 160 and 180 or the heat exchangers can be associated with other subsystems at the refinery. The heat exchangers can be arranged as a bank of heat exchangers or can be stand-alone devices.

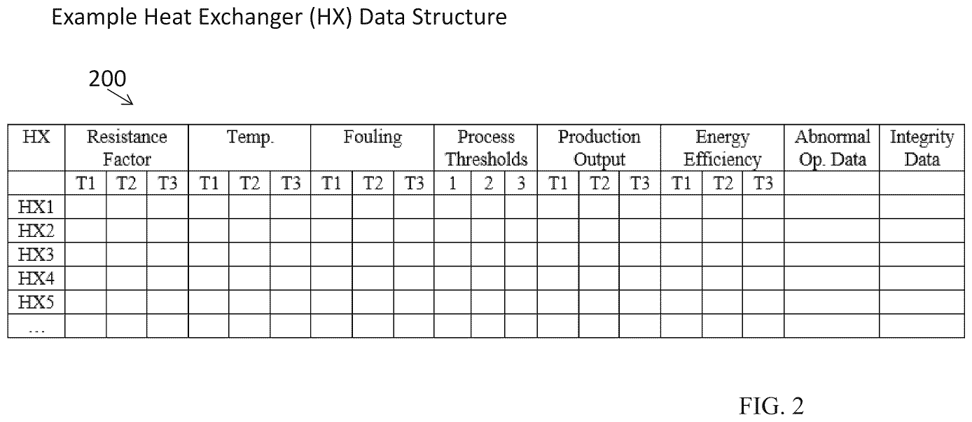

Collecting a robust set of data associated with the heat exchangers allows for more accurate prediction of the heat exchanger's future performance, which in turn allows for more accurate decisions relating to the maintenance of the heat exchangers. Referring to FIGS. 1 and 2, FIG. 2 illustrates a representative example of a data structure 200 for data associated with the heat exchangers that can be collected from the refineries. Control systems at the refineries can collect data relating to the heat exchangers and communicate the data via network 145 for storage in heat exchanger database 140 in a data structure such as example data structure 200. Several categories of data can be collected and stored in the heat exchanger database 140.

One category is operation data which is associated with the operation of each of the heat exchangers and which can be collected by control equipment at each respective refinery. Operation data can include temperature measurements at various inlet and outlet points of the heat exchanger, valve position data for valves associated with the heat exchanger, and fractionation data. If available, operation data for the heat exchanger can include resistance factor data that provides an indication of the actual heat transfer performance of the heat exchanger as compared to its optimal performance.

In addition to operation data, other categories of data associated with the heat exchanger can include process thresholds, production output, fuel usage, emissions from the combustion of fuel, abnormal operations data, and heat exchanger integrity data. Process thresholds can include one or more thresholds associated with the proper operation of the heat exchanger such as a threshold temperature for fluid exiting the heat exchanger. The production output is the amount of fluid the heat exchanger is able to produce meeting the required temperature thresholds. A minimum production output also can be used as a process threshold for the heat exchanger. Fuel usage is the amount of fuel consumed by the heat exchanger when it is performing a heating operation. Related to the fuel usage, emission data is a measure of the volume of emissions, such as carbon dioxide, resulting from the fuel usage. As will be described further below, because fouling deposits reduce the heat transfer capabilities of the heat exchanger, as fouling deposits increase, fuel usage and emissions must increase in order to maintain the production output of the heat exchanger. Therefore, the operation data, the production output, the fuel usage, and the emissions data can provide an indication of the accumulation of deposits over time on the surfaces of the heat exchanger, which is the fouling rate.

Other data provides an indication of the degradation of the heat exchanger. For example, abnormal operations data, such as data describing an increase in the amount of chloride in the fluid within the heat exchanger, provides insight into the degradation of the heat exchanger. The abnormal operations data can include both a magnitude by which the measured parameter exceeded the normal operation value and the amount of time during which the normal operation value was exceeded. In addition to abnormal operations data, integrity data provides an indication of the degradation of the heat exchanger. Integrity data can include erosion and/or corrosion measurements gathered by an inspection of the heat exchanger.

The data structure 200 illustrated in FIG. 2 provides an example for organizing some of the foregoing data associated with the heat exchanger. As illustrated in the example, data can be collected and stored in the heat exchanger database 140 for numerous heat exchangers. Data structure 200 includes operation data for the heat exchangers in the form of resistance factor data and temperature data, both of which are collected at multiple times—T1, T2, and T3. The next data element in the structure 200 is the fouling, which would be calculated at time T1, T2, and T3 from the operation data as will be described further below. After the fouling data, the process thresholds are stored in the data structure. The process thresholds are typically predetermined constants for the heat exchanger, such as a temperature threshold or a minimum production output. The actual production output measured from the performance of the heat exchanger at times T1, T2, and T3 is the next element in the data structure 200. Next, an energy efficiency for each heat exchanger can be calculated for times T1, T2, and T3 from the operation data. The energy efficiency can be calculated in a variety of ways and can include fuel usage as well as emissions data. As illustrated in FIG. 2, the data structure 200 also can include degradation data in the form of abnormal operating data and integrity (erosion/corrosion) data. It should be understood that data structure 200 is merely illustrative and in other embodiments other data structures having greater or fewer data elements can be implemented.

Referring again to FIG. 1, the system includes a computing system 105. As is commonly known for computing systems, computing system 105 includes one or more processors 110, memory 115, and input/output interfaces 120. The storage device 125 can be an integral component of the computing system 105, as illustrated in FIG. 1, or it can be external to the computing system. In addition to an operating system, the storage device can include a fouling analytics tool (“FAT”) 130 and a maintenance analytics tool (“MAT”) 135. The FAT 130 and MAT 135 can receive data from the heat exchanger database 140 via network 145 and analyze the data to provide recommendations for optimizing the maintenance of heat exchangers. The FAT includes computer executable instructions that perform methods for analyzing data associated with a heat exchanger and calculating an optimal time for performing fouling maintenance. The maintenance analytics tool includes computer executable instructions that perform methods for analyzing data related to degradation of a heat exchanger and combining the degradation analysis with the fouling analysis to calculate an optimal time for performing maintenance.

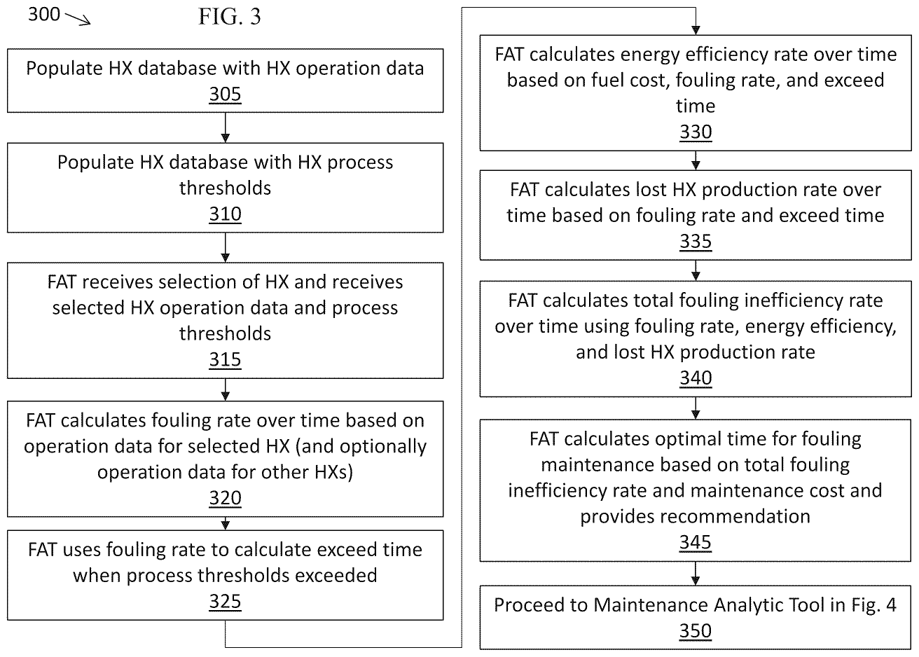

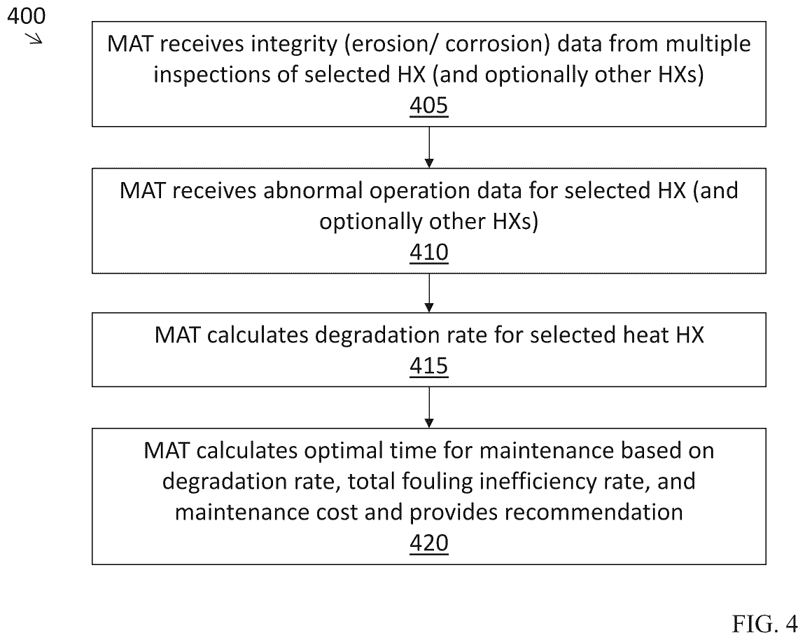

It should be understood that the computing components illustrated in FIG. 1 are merely illustrative examples and that in alternate embodiments certain of the computing components can be combined, simplified, or distributed in a different manner. While the FAT 130 and the MAT 135 are illustrated in FIG. 1 as software modules stored in storage device 125 of computing system 105, it should be understood that the FAT 130 and MAT 135 also can be implemented as services available on remote computing devices, such as the cloud, which services can be accessed to analyze heat exchanger data and provide maintenance recommendations. Additionally, while the FAT 130 and MAT 135 are described herein as separate software-implemented tools, in other embodiments these tools can be combined into a single software service or software module. Furthermore, in certain embodiments the FAT 130 and MAT 135 can include a machine learning model that is trained from historical heat exchanger data and maintenance decisions to more accurately predict the need for future maintenance on heat exchangers. The operation of the FAT 130 and MAT 135 will be described in further detail below in connection with the example methods of FIGS. 3 and 4.

Referring now to FIG. 3, an example method 300 is illustrated for using the FAT 130 to analyze heat exchanger data and determine an optimal time for performing fouling maintenance on a heat exchanger. It should be understood that in alternate example embodiments, one or more of the operations illustrated in FIG. 3 could be performed in parallel, performed a different sequence, or eliminated. Furthermore, in alternate embodiments, other operations may be added to the method of FIG. 3.

Beginning with operation 305, the heat exchanger database 140 is populated with heat exchanger operation data, such as one or more of resistance factor data, temperature data, and valve position data that is associated with the operation of the heat exchanger. The operation data can be based upon measurements gathered from the operation of the heat exchangers over time. In operation 310, the heat exchanger database 140 is populated with process thresholds for the heat exchangers, such as one or more of temperature thresholds, production output thresholds, and fuel usage thresholds. The process thresholds are typically predefined constant values associated with the normal operation of the heat exchangers or preferred operating ranges for the heat exchangers. The population of the heat exchanger database 140 with the operation data and process thresholds can be performed by the FAT 130 or by other software associated with the system of FIG. 1.

With the data available in the heat exchanger database 140, the FAT 130 can analyze the data to predict the impact of fouling on the operation of the heat exchangers and to determine an optimal time for performing maintenance. In operation 315, the FAT 130 can receive a selection of a heat exchanger that has been identified for analysis and possible maintenance. With the selected heat exchanger identified, the FAT 130 can receive the operation data and process thresholds for the selected heat exchanger from the heat exchanger database 140. The operation data provides an indication of fouling deposits accumulating on the surfaces of the selected heat exchanger. With the operation data, in operation 320, the FAT 130 can calculate a prediction of the rate at which fouling deposits will accumulate on the heat exchanger in the future, which can be referred to as the fouling rate. Optionally, the FAT 130 also can analyze operation data collected from other heat exchangers that are similar to the selected heat exchanger, which data may improve the accuracy of the predicted fouling rate for the selected heat exchanger. For example, if the FAT 130 includes machine learning techniques, a machine learning model can be trained with prior data from similar heat exchangers in order to more accurately predict the fouling rate for the selected heat exchanger.

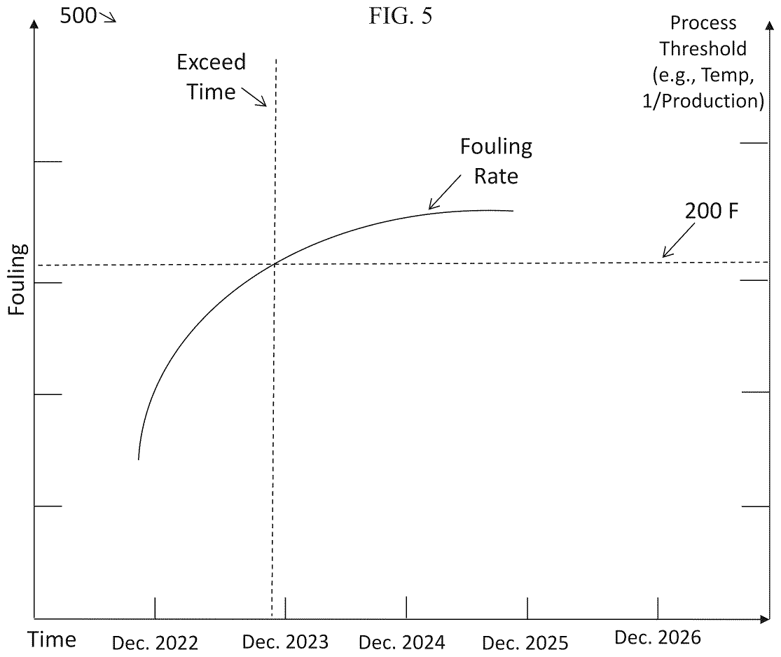

In operation 325, the FAT 130 uses the calculated fouling rate for the selected heat exchanger to calculate an exceed time when one or more of the process thresholds will be exceeded. For example, if a process threshold is a maximum temperature threshold for a fluid exiting the selected heat exchanger, the fouling of the heat exchanger may interfere with the proper operation of the heat exchanger causing the temperature threshold to be exceeded at an exceed time based on the calculated fouling rate. The exceed time can be critical to the analysis as the exceed time can indicate a time after which the efficiency or the production output of the selected heat exchanger drops to unacceptable levels. The relationship of the fouling rate and exceed time is illustrated in the example data plot provided in FIG. 5. As shown in the data plot, the fouling rate for the selected heat exchanger increases over time until it causes the selected heat exchanger to exceed a process threshold of 200 F. The predicted time at which the fouling rate causes the selected heat exchanger to exceed the process threshold is labeled as the exceed time. The FAT 130 can display the data plot or similar types of data plots to a user via a user interface to assist with reviewing the analysis performed by the FAT 130. While example method 300 and example data plot 500 refer to a single exceed time, it should be understood that more complex examples can involve calculating multiple exceed times. For instance, a first exceed time can be associated with a first fuel usage rate. After reaching the first exceed time, the fuel usage rate can be increased to a second fuel usage rate in order to maintain a temperature or other variable within a process threshold. A second exceed time can be calculated based on when a process threshold such as temperature will be exceeded at the second fuel usage rate. Similarly, a third exceed time could be calculated for when the fuel usage rate can no longer be increased and production would need to be decreased in order to avoid exceeding the process threshold.

Referring to operation 330, the FAT 130 can use the fouling rate and the exceed time determined in the previous operations to calculate a predicted energy efficiency rate over time for the selected heat exchanger. The energy efficiency rate is typically inversely proportional to the fouling rate because as the fouling deposits increase, the efficiency of the selected heat exchanger decreases. The energy efficiency rate also can include other data such as the cost of fuel. For instance, if the cost of fuel is expected to increase over time, this increase will negatively affect the energy efficiency rate. If the effect of emissions from burning fuel is of interest, emissions data also can be incorporated into the calculated energy efficiency rate. For example, the volume of emissions can be incorporated into the calculation as a cost that impacts the calculated energy efficiency rate. In this way, maintenance decisions can be weighted by the impact of harmful emissions from the operation of the selected heat exchanger.

In operation 335, the FAT 130 can use the fouling rate and the exceed time determined in the previous operations to calculate a predicted lost production rate over time for the selected heat exchanger. The lost production rate over time typically correlates with the fouling rate and the exceed time because as fouling deposits increase and process thresholds are exceeded, the production output is negatively impacted. The FAT 130 also can use the measurements of previous production output at various times, as illustrated in the data structure of FIG. 2, in establishing a baseline or trend for calculating the lost production rate.

Referring now to operation 340, the FAT 130 can use the fouling rate, the energy efficiency rate, and the lost production rate determined in the previous operations to calculate a total fouling inefficiency rate over time for the selected heat exchanger. The total fouling inefficiency rate provides an indicator of the selected heat exchangers expected performance. The total fouling inefficiency rate is useful because it is a function of many different inputs, including the previously described operation data, energy efficiency data, and production output data. These different inputs can be weighted to influence decisions about when maintenance should be performed on the heat exchanger. For example, if energy efficiency and reducing emissions is a priority, the energy efficiency rate can be weighted more heavily in calculating the total fouling inefficiency rate over time.

It should be understood that the FAT 130 also can make multiple calculations for different operating conditions or time periods. For example, during a first time period applying a first fuel usage rate, the FAT 130 can calculate a fouling rate (operation 320), an exceed time (325), a predicted energy efficiency rate (operation 330), and a predicted lost production rate (335). The FAT 130 also can perform the calculations of operations 320 through 335 for a different set of operating conditions such as a second time period applying a second fuel usage rate or a different production output.

Referring to operation 345, the FAT 130 can calculate an optimal time for performing fouling maintenance based on the total fouling inefficiency rate calculated in operation 340 as well as the costs for maintenance. For example, the FAT 130 can predict the time at which the costs associated with the total fouling inefficiency rate will exceed the costs of performing maintenance and this predicted time can be referred to as the optimal time for fouling maintenance. The FAT 130 can provide the optimal time as an output in the form of a report or recommendation provided via a user interface to a user. It should be understood that one more of the operations of example method 300 can be repeated when new heat exchanger data becomes available in order to provide more accurate predictions.

The fouling maintenance of operation 345 refers to shutting down operations to perform cleaning on the heat exchanger to remove accumulated deposits or to replace either components or the entire heat exchanger. The maintenance referenced in operation 345 is referred to as “fouling maintenance” because the decision is based upon fouling data. In contrast, method 400 of FIG. 4, as will be described below, uses the broader term “maintenance” because the decision is based upon both fouling data and degradation data. Optionally, if the user is only interested in a broader analysis that considers both fouling data and degradation data, operation 345 can be omitted and the process can proceed to FIG. 4 and the operations of the MAT as indicated by operation 350.

Referring now to FIG. 4, an example method 400 is illustrated for using the MAT 135 to analyze heat exchanger data and determine an optimal time for performing maintenance on a heat exchanger. Example method 400 builds upon example method 300 in that it uses the previous fouling analysis in combination with analysis of degradation data for the selected heat exchanger to provide a recommended time for performing maintenance on the heat exchanger. It should be understood that in alternate example embodiments, one or more of the operations illustrated in FIG. 4 could be performed in parallel, performed in a different sequence, or eliminated. Furthermore, in alternate embodiments, other operations may be added to the method of FIG. 4.

Beginning with operation 405, the MAT 135 receives integrity data for the selected heat exchanger from the heat exchanger database 140. The integrity data refers to corrosion and/or erosion of the components of the heat exchanger. The integrity data can be gathered from previous inspections of the heat exchanger and can be stored in the heat exchanger database 140 to support analysis of the heat exchanger. The inspections of the heat exchanger can include visual inspections of the interior or exterior of the heat exchanger as well as inspections performed using devices. Optionally, the MAT also can receive integrity data for other similar heat exchangers that can be used to improve the accuracy of predictions for the selected heat exchanger.

In operation 410, the MAT 135 receives abnormal operation data for the selected heat exchanger from the heat exchanger database 140. The degradation of the heat exchanger is often exacerbated during periods of abnormal operation of the heat exchanger. Accordingly, including abnormal operation data can improve the accuracy of the analysis of the selected heat exchanger. As referenced previously, abnormal operation data can include a variety of measurements. As one example, a measurement of chloride levels in the fluid passing through the heat exchanger during an abnormal operation can be relevant to degradation.

Referring to operation 415, the MAT 135 calculates a degradation rate for the selected heat exchanger from the integrity data and the abnormal operation data. For example, observations of substantial corrosion or erosion will result in an increased degradation rate. Similarly, abnormal operation data indicating prolonged periods of abnormal operation will increase the degradation rate for the selected heat exchanger.

In operation 420, the MAT 135 calculates an optimal time for performing maintenance on the selected heat exchanger. The optimal time for maintenance is calculated based on the degradation rate, the total fouling inefficiency rate from method 300, and the cost of performing the maintenance. For example, the MAT 135 can predict the time at which the costs associated with the degradation rate and the total fouling inefficiency rate will exceed the costs of performing maintenance and this predicted time can be referred to as the optimal time for performing maintenance. The MAT 135 can provide the optimal time as an output in the form of a report or recommendation provided via a user interface to a user. It should be understood that one more of the operations of example method 400 can be repeated when new heat exchanger data becomes available in order to provide more accurate predictions. For example, the MAT 135 can include a machine learning model that can be trained with prior data from similar heat exchangers in order to more accurately predict the degradation rate for the selected heat exchanger and the optimal time for maintenance. The MAT 135 can then apply the trained machine learning model as new integrity data or abnormal operation data becomes available to provide more accurate predictions. Maintenance in operation 420 refers to shutting down operations to perform cleaning on the heat exchanger to remove accumulated deposits or to replace either components or the entire heat exchanger.

### General Information Regarding Computing Systems

As described in connection with FIGS. 1-5, some or all of the processing operations described in connection with the foregoing systems and methods can be performed by computing systems such as a personal computer, a desktop computer, a computer server, or cloud computing systems. As explained previously, certain operations of the foregoing methods can be performed by a combination of computing systems.

The computing systems used in the foregoing embodiments can include typical components such as one or more processors, memories, input/output devices, and a storage devices. The components of the computing systems can be interconnected, for example, by a system bus or by communication links. The components of the previously described computing systems are not exhaustive.

The one or more processors can be one or more hardware processors and can execute computer-readable instructions, such as instructions stored in a memory. The processor can be an integrated circuit, a central processing unit, a multi-core processing chip, an SoC, a multi-chip module including multiple multi-core processing chips, or other hardware processor in one or more example embodiments. The hardware processor is known by other names, including but not limited to a computer processor, a microprocessor, and a multi-core processor.

The memory can store information including computer-readable instructions and data. The memory can be cache memory, a main memory, and/or any other suitable type of memory. The memory is a non-transitory computer-readable medium. In some cases, the memory can be a volatile memory device, while in other cases the memory can be a non-volatile memory device.

The storage device can be a non-transitory computer-readable medium that provides large capacity storage for a computing system. The storage device can be a disk drive, a flash drive, a solid state device, or some other type of storage device. In some cases, the storage device can be a database that is remote from the computing system. The storage device can store operating system data, file data, database data, algorithms, and software modules, as examples.

### Assumptions and Definitions

For any figure shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

The term “obtaining” may include receiving, retrieving, accessing, generating, etc. or any other manner of obtaining data.

Terms such as “first” and “second” are used merely to distinguish one element (or state of an element) from another. Such terms are not meant to denote a preference and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A computing system comprising:
a processor;
a memory; and
a storage device comprising a fouling analytics tool, the fouling analytics tool comprising computer-executable instructions that:
receive operation data for a heat exchanger;
receive a process threshold for the heat exchanger;
calculate a fouling rate for the heat exchanger based upon the operation data;
calculate an exceed time that occurs when the process threshold is exceeded based upon the fouling rate;
calculate a total fouling inefficiency rate for the heat exchanger based on the fouling rate, an energy efficiency rate for heat exchanger, and a lost production rate for the heat exchanger;
calculate an optimal time for performing fouling maintenance on the heat exchanger based upon the total fouling inefficiency rate for the heat exchanger and a cost associated with performing the maintenance; and
provide a recommended maintenance plan based upon the optimal time for performing fouling maintenance on the heat exchanger.

2. The computing system of claim 1, wherein the storage device further comprises a maintenance analytics tool, the maintenance analytics tool comprising computer-executable instructions that:
receive integrity data for the heat exchanger;
receive abnormal operation data for the heat exchanger;
calculate a degradation rate for the heat exchanger based upon the integrity data and the abnormal operation data; and
calculate an optimal time for performing maintenance on the heat exchanger based upon the degradation rate and the total fouling inefficiency rate.

3. The computing system of claim 1, wherein the operation data for the heat exchanger comprises resistance factor data and temperature data.

4. The computing system of claim 1, wherein the process threshold for the heat exchanger is one of a temperature threshold, a fuel usage threshold, and a production threshold.

5. The computing system of claim 1, wherein calculating the energy efficiency rate is based upon the fouling rate, the exceed time, a fuel cost, and an emissions rate.

6. The computing system of claim 2, wherein the maintenance analytics tool further comprises computer-executable instructions that:
receive integrity data for at least a second heat exchanger;
receive abnormal operation data for at least the second heat exchanger; and
use the integrity data and the abnormal operation data for at least the second heat exchanger when calculating the degradation rate for the heat exchanger.

7. The computing system of claim 1, wherein the fouling analytics tool further comprises computer-executable instructions that:
calculate an optimal time for performing fouling maintenance on a second heat exchanger, wherein the heat exchanger and the second heat exchanger comprise a heat exchanger bank; and
calculate an optimal time for performing fouling maintenance on the heat exchanger bank by averaging the optimal time for the heat exchanger and the optimal time for the second heat exchanger.

8. A computer-implemented method for managing maintenance of a heat exchanger, the method comprising:
receiving operation data for the heat exchanger;
receiving a process threshold for the heat exchanger;
calculating, by a fouling analytics tool, a fouling rate for the heat exchanger based upon the operation data;
calculating, by the fouling analytics tool, an exceed time that occurs when the process threshold is exceeded based upon the fouling rate;
calculating, by the fouling analytics tool, a total fouling inefficiency rate for the heat exchanger based on the fouling rate, an energy efficiency rate for heat exchanger, and a lost production rate for the heat exchanger;
calculating, by the fouling analytics tool, an optimal time for performing fouling maintenance on the heat exchanger based upon the total fouling inefficiency rate for the heat exchanger and a cost associated with performing the maintenance; and
providing, by the fouling analytics tool, a recommended maintenance plan based upon the optimal time for performing fouling maintenance on the heat exchanger.

9. The method of claim 8, further comprising:
receiving, by a maintenance analytics tool, integrity data for the heat exchanger;
receiving, by the maintenance analytics tool, abnormal operation data for the heat exchanger;
calculating, by the maintenance analytics tool, a degradation rate for the heat exchanger based upon the integrity data and the abnormal operation data; and
calculating, by the maintenance analytics tool, an optimal time for performing maintenance on the heat exchanger based upon the degradation rate and the total fouling inefficiency rate.

10. The method of claim 8, wherein the operation data for the heat exchanger comprises resistance factor data and temperature data.

11. The method of claim 8, wherein the process threshold for the heat exchanger is one of a temperature threshold, a fuel usage threshold, and a production threshold.

12. The method of claim 8, wherein calculating the energy efficiency rate is based upon the fouling rate, the exceed time, a fuel cost, and an emissions rate.

13. The method of claim 9, further comprising:
receiving, by the maintenance analytics tool, integrity data for at least a second heat exchanger;
receiving, by the maintenance analytics tool, abnormal operation data for at least the second heat exchanger; and
using the integrity data and the abnormal operation data for at least the second heat exchanger when calculating the degradation rate for the heat exchanger.

14. The method of claim 8, further comprising:
calculating, by the fouling analytics tool, an optimal time for performing fouling maintenance on a second heat exchanger, wherein the heat exchanger and the second heat exchanger comprise a heat exchanger bank; and
calculating an optimal time for performing fouling maintenance on the heat exchanger bank by averaging the optimal time for the heat exchanger and the optimal time for the second heat exchanger.

15. A computer-readable medium comprising instructions that when executed by a processor perform a method comprising:
receiving operation data for the heat exchanger;
receiving a process threshold for the heat exchanger;
calculating, by a fouling analytics tool, a fouling rate for the heat exchanger based upon the operation data;
calculating, by the fouling analytics tool, an exceed time that occurs when the process threshold is exceeded based upon the fouling rate;
calculating, by the fouling analytics tool, a total fouling inefficiency rate for the heat exchanger based on the fouling rate, an energy efficiency rate for heat exchanger, and a lost production rate for the heat exchanger;
calculating, by the fouling analytics tool, an optimal time for performing fouling maintenance on the heat exchanger based upon the total fouling inefficiency rate for the heat exchanger and a cost associated with performing the maintenance; and
providing, by the fouling analytics tool, a recommended maintenance plan based upon the optimal time for performing fouling maintenance on the heat exchanger.

16. The computer-readable medium of claim 15, wherein the method further comprises:
receiving, by a maintenance analytics tool, integrity data for the heat exchanger;
receiving, by the maintenance analytics tool, abnormal operation data for the heat exchanger;
calculating, by the maintenance analytics tool, a degradation rate for the heat exchanger based upon the integrity data and the abnormal operation data; and
calculating, by the maintenance analytics tool, an optimal time for performing maintenance on the heat exchanger based upon the degradation rate and the total fouling inefficiency rate.

17. The computer-readable medium of claim 15, wherein the operation data for the heat exchanger comprises resistance factor data and temperature data.

18. The computer-readable medium of claim 15, wherein the process threshold for the heat exchanger is one of a temperature threshold, a fuel usage threshold, and a production threshold.

19. The computer-readable medium of claim 15, wherein calculating the energy efficiency rate is based upon the fouling rate, the exceed time, a fuel cost, and an emissions rate.

20. The computer-readable medium of claim 16, wherein the method further comprises:
receiving, by the maintenance analytics tool, integrity data for at least a second heat exchanger;
receiving, by the maintenance analytics tool, abnormal operation data for at least the second heat exchanger; and
using the integrity data and the abnormal operation data for at least the second heat exchanger when calculating the degradation rate for the heat exchanger.
